(19) United States
(12) Patent Application Publication
(10) Pub. No.: US 2006/0245919 A1
(43) Pub. Date: Nov. 2, 2006

(54) Water wheel motor

(76) Inventors: Vladislav Krizik, Martin Slovakia (SK); Ján Macek, martin Slovakia (SL)

Correspondence Address: HOVEY WILLIAMS LLP, 2405 GRAND BLVD., SUITE 400, KANSAS CITY, MO, 64108, US

(21) Appl. No.: 10/554,163

(22) PCT Filed: Apr. 30, 2004
(86) PCT No.: PCT/SK04/00005

§ 371 Date: Oct. 21, 2005

(30) Foreign Application Priority Data
Apr. 30, 2003 (SK) PUV 103-2003

(51) Int. Cl. F03B 1/04

(52) U.S. Cl. 415/202

(57) ABSTRACT

The water wheel motor consisting of the outlet device (1) located in front of the wheel (5) and of the drain device (6) located under the wheel (5), which can rotate on the rotation axes (18) and on which the isobaric paddles (4) are fixed. All points of the wheel (5) and of the isobaric paddles (4) are in the bigger distance or in zero distance above the plane (21), which is identical with the plane (19) or lower and at the same time parallel to the plane (19) limiting the upper level of the drain device (6) space containing water. The axis (2) of the outlet device (1) is directed on the isobaric paddles (4) and the rotation axis (18) of the wheel (5) is in the vertical, horizontal or oblique position.

### FIELD OF THE INVENTION

The technical solution refers to the equipment for change of hydro-energetic potential of water flow to the mechanical energy with the possibility of further transformation of the energy into another form.

### BACKGROUND OF THE INVENTION

At the presence there are many types of the equipments used in the world for transformation of hydro-energetic potential of water flow to the mechanical energy with the possibility to transform this energy into another form. According to their design and the way of energy transformation they are divided into water wheels and water turbines.

The water wheels are actuated by upper, middle and lower drive. The water wheels with upper drive use the potential energy of water. They are of the bucket type, rotating between the upper and lower water level. Water from the upper level flows into the buckets and turns the wheel by the water gravity; water flows out on the lower level. The operating conditions of water wheels with upper drive are: The water level difference from 3 to 12 m, water flow rate from 0.3 to 1.0 m³·s⁻¹

The water wheels with middle and lower drive are of the paddle type, they rotation axis is above the lower level and the water wheel paddles take the energy from the water by wading in the lower flow, created by stream coming from the upper level. The water wheel with middle drive use partially the potential energy and partially the kinetic energy of water streaming between the water wheel paddles approximately at the level of water wheel rotation axis. They are represented by Sagebien, Zuppinger and Piccard wheels. The water wheels with lower drive use only the kinetic energy of water flowing between the water wheel paddles in the tangential direction at the lower part of the water wheel. The representant of this type is the Poncelet wheel.

The water wheel paddles are plane, or slightly bent in the plane perpendicular to the water wheel rotation axis. The operating conditions of water wheels with middle and lower drive are: The difference between water levels from 0.5 to 4.0 m, flow rates from 0.5 to 4.0 m³·s⁻¹. The efficiency of all water wheels moves from 60 to 70%. The advantage of water wheels is their simple design and low price. Their disadvantage is their low efficiency and a small range of operating conditions. The low efficiency is caused by paddle shape and their resistance by wading in water. The small range of operation conditions results from the relation between the water wheel dimension and the difference of water levels.

The water turbines are classified, according to the water energy type they use, to the isobaric and overpressure type and according to the turbine water flow direction to radial, axial, radial-axial, diagonal, tangential, with oblique flow and double flow. The isobaric turbines—Pelton and Banki turbine, take the water kinetic energy.

The Pelton turbine is of tangential type. Water is supplied via pressure pipe with a nozzle on its end, where its pressure energy is transformed into the kinetic one and the stream of water is sprayed in tangential direction on the space shaped turbine paddles along the turbine rotor circumference. The turbine rotor rotates in the air above the lower water level. The rotation axis can be horizontal and vertical. The operation ranges are: The difference between water levels from 30 to 900 m, flow rates from 0.02 to 1.0 m³·s⁻¹. The efficiency moves up to 91%.

The Banki turbine with double radial flow through the paddle wheel has a horizontal rotation axis. The wheel paddles take the kinetic energy from water streaming out of regulation flap, located immediately above the turbine wheel. The operation conditions are: The difference between water levels from 1.5 to 50 m, flow rates from 0.02 to 1.5 m³·s⁻¹. The efficiency moves up to 85%.

The representatives of water overpressure turbines are: Kaplan turbine, Francisci turbine, and their different modifications, for example so called propeller or suction turbine.

The Kaplan turbine is of axial type. The operation conditions are: The difference between water levels from 1.5 to 75 m, flow rates from 0.2 to 20 m³·s⁻¹. The efficiency moves from 88 to 95%.

The Francis turbine is of radial-axial type. The operation ranges are: The difference between water levels from 10 to 400 m, flow rates from 0.05 to 15 m³·s⁻¹. The efficiency moves from 88 to 95%.

The advantage of water turbines is a big range of operation conditions and higher efficiency. Their disadvantage is the complicated equipment and high price.

### DESCRIPTION OF THE INVENTION

In the proposed technical solution the advantages of water wheel, simple design and low price, are combined with the advantages of water turbine; the water wheel motor, for energetic use of hydro-energetic potential of the water flow, consists of the outlet device, drain device, wheel and isobaric paddles fixed to the wheel, which can rotate around the rotation axis.

The wheel with fixed isobaric paddles rotates around its rotation axis and has such a position, in relation to the drain device, that all paddle points are in the zero or bigger distance above the plane, which is identical or lower and at the same time parallel to the plane limiting the drain device space containing water.

The rotation axis of the wheel with isobaric paddles can be vertical, horizontal or oblique.

The outlet device, thanks to its shape and position of its axis in relation to the isobaric paddle wheel, guides the water stream, created by the hydro-energetic water potential, to the isobaric paddles fixed to the wheel.

The isobaric paddles take the kinetic energy from water streaming on them and exerting the force on them, and they change this energy to the mechanical energy of the wheel rotary movement. The isobaric paddles, due to their shape, size, position in relation to the water stream, direction, shape of their trajectory and relative speed of their movement against the water stream, determine the transformation efficiency of kinetic water energy to the mechanical energy.

The wheel design enables the further transport of its rotation movement energy, gained by means of the isobaric paddles from the kinetic water energy, to other technical equipments.

The water stream, guided by the outlet equipment on the isobaric wheel paddles, falls from the isobaric wheel paddles, after giving them its kinetic energy, on the water surface, which is identical or lower and at the same time parallel with the plane limiting the space of drain device containing water, which is located below the wheel.

### DESCRIPTION OF THE DRAWINGS

FIG. 1—diagram explaining the nature of technical solution of the water wheel motor.

FIG. 2—small hydroelectric power plant with inlet channel, pressure shaft and water wheel motor with horizontal rotation axis.

FIG. 3—small hydroelectric power plant with inlet channel, pressure shaft and water wheel motor with vertical rotation axis.

FIG. 4—small hydroelectric power plant with inlet channel, water slip and water wheel motor with horizontal rotation axis.

FIG. 5—small hydroelectric power plant with water level heaved by a steel damper and with four independent water wheel motor with horizontal rotation axis.

FIG. 6—small hydroelectric power plant on the weir of the water flow with water wheel motor with vertical rotation axis.

FIG. 7—small hydroelectric power plant on the heaved weir with water wheel motor with horizontal rotation axis.

FIG. 8—small hydroelectric power plant on the overflow over the steel damper of the water flow with water wheel motor, with horizontal rotation axis.

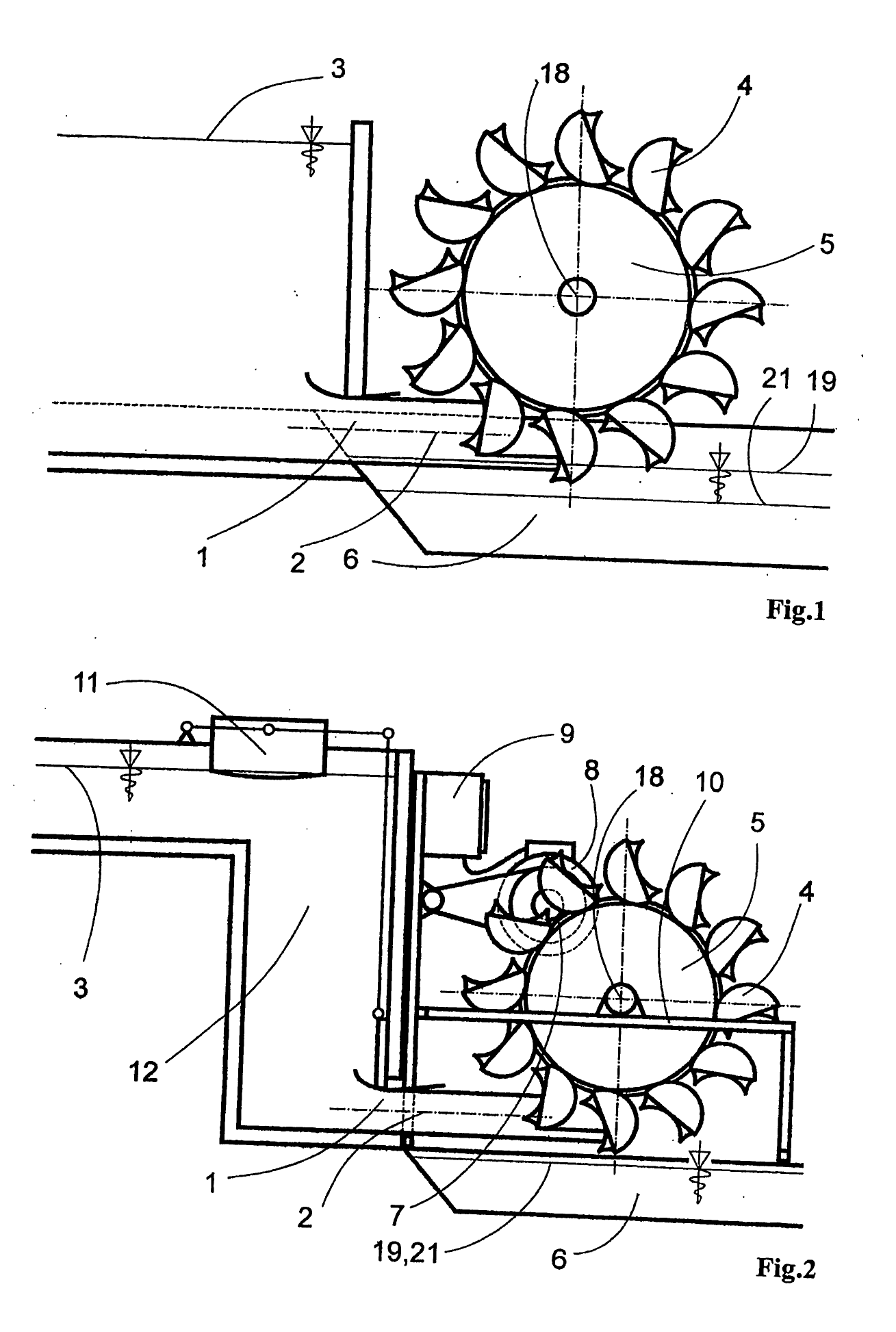

### EXAMPLES

The proposed technical solution in the FIG. 2 was used for the design of a small hydro-electric power plant of micro plants category, with the level difference of 2.8 m, flow rate 0.125 to 1.0 m³·s⁻¹ and with installed capacity of 22 kW. The equipment in the FIG. 2 consists of upper water level inlet channel 3, pressure shaft 12, regulating outlet device 1, floater regulator 11 of the outlet equipment 1, isobaric paddles 4 fixed on the wheel 5 with horizontal rotation axis 18, drain device 6, friction transmission 7, generator 8, electric part of the micro-electric power plant 9, equipment carrying frame 10.

The inlet channel for upper level 3 guides water into the pressure shaft 12, where the water, by acting of water column hydrostatic pressure, sprays via outlet device 1 in direction of axis 2 of the outlet device 1 on the isobaric paddles 4 of the wheel 5, which creates the torque on the wheel 5 embedded on the horizontal rotation axis 18 in the equipment frame 10. The torque is transmitted from the wheel 5 via friction transmission 7 to the generator 8. The water from paddles 4 falls on the water surface, which is identical with the plane 21 and this is identical with the plane 19 or is in lower position and at the same time it is parallel with the plane 19 limiting the upper level of the water containing drain device 6. The electric part 9 of the micro electric power plant ensures the technical parameters required for connection of generator 8 into the public electricity network. The floater regulator 11 keeps, by regulating the outlet device 1, the constant upper water level 3, disregarding the water supply in the inlet channel.

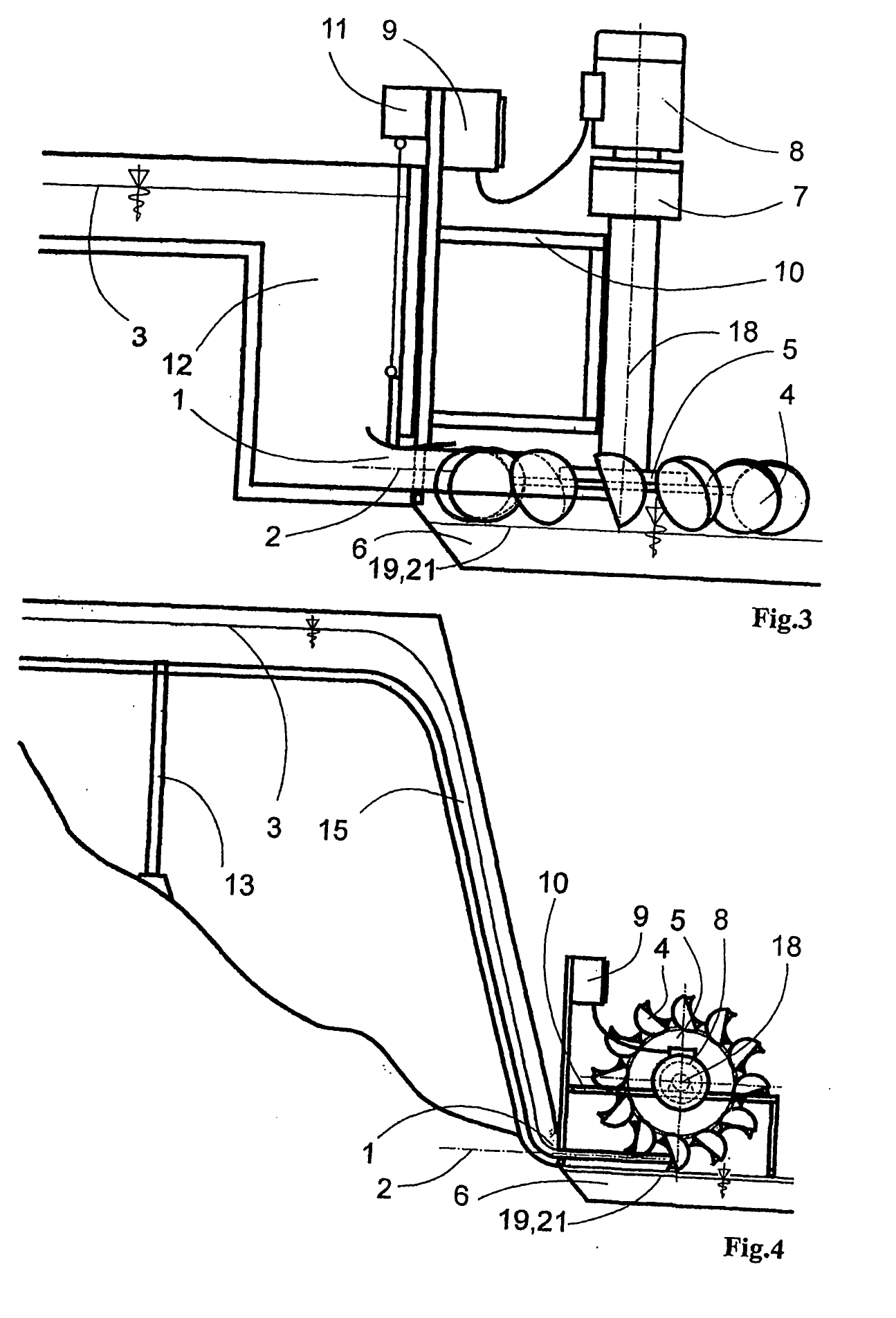

The proposed technical solution in the FIG. 3 was used for the design of a small hydro-electric power plant of micro plant category, with the level difference of 2.0 m, flow rate 0.25 to 2.0 m³·s⁻¹ and with installed capacity of 30 kW. The equipment in the FIG. 3 consists of upper water level inlet channel 3, pressure shaft 12, regulating outlet device 1, regulator 11 of the outlet equipment 1, with opto-electronic water level sensor, isobaric paddles 4 fixed on the wheel 5 with vertical rotation axis 18, drain device 6, friction transmission 7, generator 8, electric part of the micro-electric power plant 9, equipment carrying frame 10.

The inlet channel for upper level 3 guides water into the pressure shaft 12, where the water, by acting of water column hydrostatic pressure, sprays via outlet device 1 in direction of axis 2 of the outlet device 1 on the isobaric paddles 4 of the wheel 5, which creates the torque on the wheel 5 embedded on the vertical rotation axis 18 in the equipment frame 10. The torque is transmitted from the wheel 5 via gearbox 7 to the generator 8. The water from paddles 4 falls on the water surface, which is identical with the plane 21 and this is identical with the plane 19 or is in lower position and at the same time it is parallel with the plane 19 limiting the upper level of the water containing drain device 6. The electric part 9 of the micro electric power plant ensures the technical parameters required for connection of generator 8 into the public electricity network. The regulator 11 of the outlet device 1 with opto-electronic water level sensor keeps, by regulating the outlet device 1 the constant upper water level 3, disregarding the water supply in the inlet channel.

The proposed technical solution in the FIG. 4 was used for the design of a small hydro-electric power plant of micro plant category, with the level difference of 14.0 m, flow rate 0.035 to 0.28 m³·s⁻¹ and with installed capacity of 37 kW. The equipment is designed with respect to the high water speed achieved in the outlet on the wheel so that the wheel revolutions are identical with required revolutions for generator and speed change is necessary. The equipment in the FIG. 4 consists of upper water level inlet channel 3, water slip 15, outlet device 1, isobaric paddles 4 fixed on the wheel 5 with horizontal rotation axis 18, drain device 6, generator 8, electric part of the micro-electric power plant 2, carrying structure of channel 13, equipment carrying frame 10.

The inlet channel for upper level 3 guides water to the water slip 15, where the water energetic potential, by acting of gravity force, is changed into the kinetic energy, which makes the water to spry via outlet device 1 in direction of axis 2 of the outlet device 1 on the isobaric paddles 4 of the wheel 5, which creates the torque on the wheel 5 embedded on the horizontal rotation axis 18 in the equipment frame 10. The torque is transmitted from the wheel 5 directly to the generator 8. The water from paddles 4 falls on the water surface, which is identical with the plane 21 and this is identical with the plane 19 or is in lower position and at the same time it is parallel with the plane 19 limiting the upper level of the water containing drain device 6. The electric part 9 of the micro electric power plant ensures the technical parameters required for connection of generator 8 into the public electricity network.

The proposed technical solution in the FIG. 5 was used for the design of a small hydro-electric power plant with the level difference of 4.2 m, flow rate 0.375 to 12.0 m³·s⁻¹ and with installed capacity of 380 kW. The equipment in FIG. 5 consists of the flow heaving dam to upper level 3, four outlet equipments 1, outlet equipment regulator 11 with opto-electronic water level sensor, four wheels 5 with fixed isobaric paddles 4 and with horizontal rotation axis 18, drain device 6, four friction transmissions 7a, four gearboxes 7b, four generators 8, electric part of the micro-electric power plant 9 and of equipment carrying frame 10

The hydrostatic pressure of the water column, created by heaving the upper water level 3, sprays the water via outlet devices 1 in the direction of axis 2 of the outlet devices 1 on the isobaric paddles 4 of the wheels 5, which creates the torque on the wheels 5 embedded on the horizontal rotation axis 18 in the equipment carrying frame 10. The torque is transmitted from the wheels 5 via friction transmission 7a and gearboxes 7b to the generators 8. The water from paddles 4 falls on the water surface, which is identical with the plane 21 and this is identical with the plane 19 or is in lower position and at the same time it is parallel with the plane 19 limiting the upper level of the water containing drain device 6. The electric part 9 of the micro electric power plant ensures the technical parameters required for connection of generators 8 into the public electricity network. The regulator 11 of the outlet devices 1 with opto-electronic water level sensor keeps, by regulating the outlet devices 1, the constant upper water level 3, disregarding the water supply to the flow heaving dam.

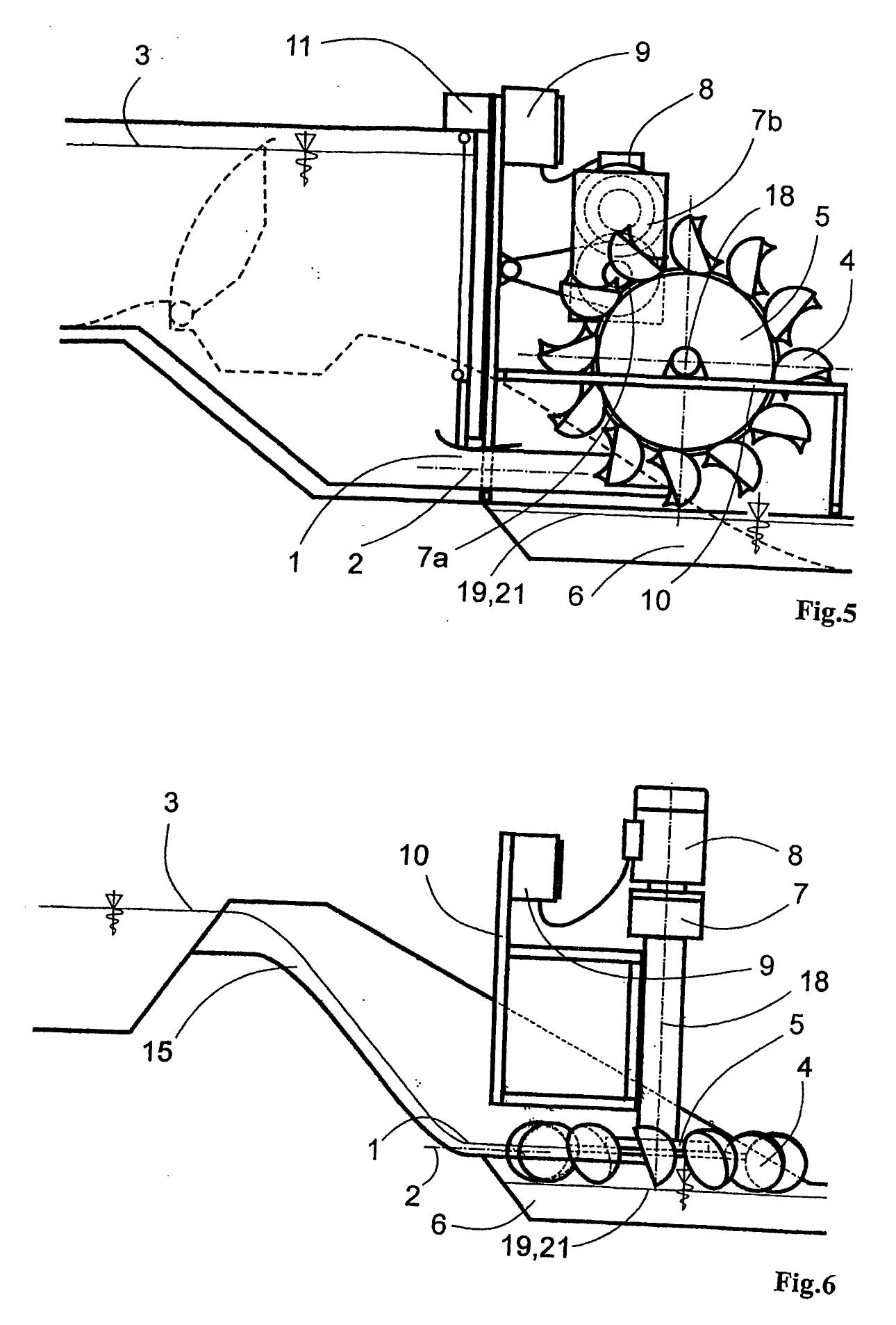

The proposed technical solution in the FIG. 6 was used for the design of a small hydro-electric power plant on the weir with the level difference of 3.1 m, flow rate 0.06 to 0.5 m³·s⁻¹ and with installed capacity of 11 kW. The equipment in the FIG. 4 consists of the inlet water slip 15, outlet device 1, isobaric paddles 4 fixed on the wheel 5 with vertical rotation axis 18, drain device 6, gearbox 7, generator 8, electric part of the micro-electric power plant 9 and of equipment carrying frame 10.

The weir heaves the upper water level 3 and water runs over the weir upper edge where the hydro-energetic potential of water falling in the water slip 15 is changed, by acting of gravity force, into the kinetic energy, which makes the water to spry via outlet device 1 in the direction of axis 2 of the outlet device 1 on the isobaric paddles 4 of the wheel 5, which creates the torque on the wheel 5 embedded on the vertical rotation axis 18 in the equipment carrying frame 10. The torque is transmitted from the wheel 5 via gearbox 7 to the generator 8. The water from paddles 4 falls on the water surface, which is identical with the plane 21 and this is identical with the plane 19 or is in lower position and at the same time it is parallel with the plane 19 limiting the upper level of the water containing drain device 6. The electric part 9 of the micro electric power plant ensures the technical parameters required for connection of generator 8 into the public electricity network.

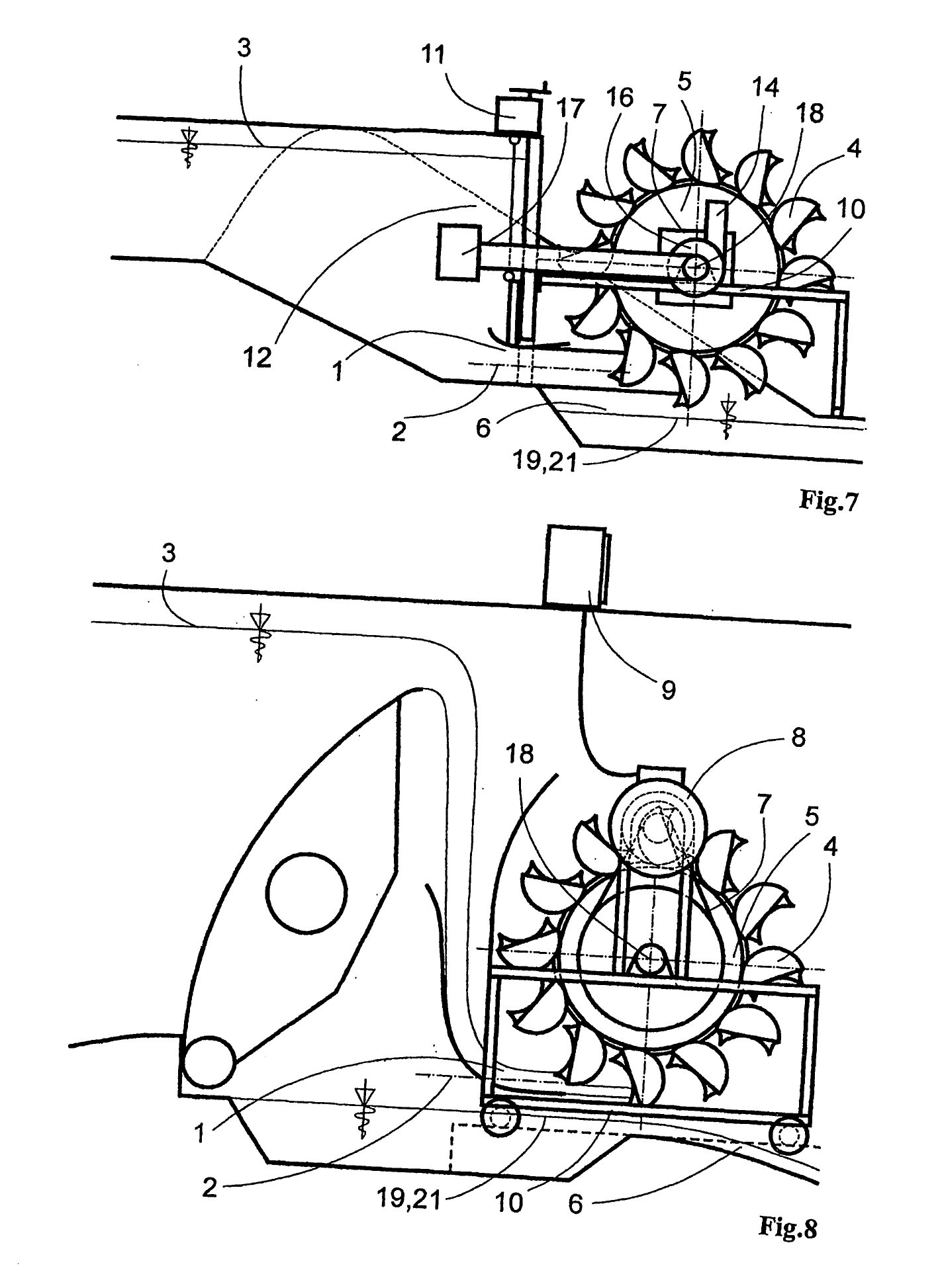

The proposed technical solution in the FIG. 7 was used for the design of irrigation equipment on the flowing with level difference of 2.2 m, flow rate 2.2 m³·s⁻¹, with discharge height of 30 m and capacity of 100 ltrs/s. The equipment in FIG. 7 consists of pressure shaft 12, outlet device 1 with manual regulator 11 of outlet device 1, isobaric paddles 4 fixed on wheel 5 with horizontal rotation axis 18, drain device 6, water centrifugal pump 16 with gearbox 7, suction pipe with strainer 17, discharge pipe 14, equipment carrying frame 10.

The flowing heaves upper water level 3, connected with the pressure shaft 12, where the water, by acting of water column hydrostatic pressure, sprays via outlet device 1 in direction of axis 2 of the outlet device 1 on the isobaric paddles 4 of the wheel 5, which creates the torque on the wheel 5 embedded on the horizontal rotation axis 18 in the equipment carrying frame 10. The torque is transmitted via gearbox 7 from the wheel 5 on the centrifugal water pump 16, which sucks water from the heaved water level space via suction pipe with strainer 17 and discharges it via discharge pipe 14 into the agricultural irrigation system. The water from paddles 4 falls on the water surface, which is identical with the plane 21 and this is identical with the plane 19 or is in lower position and at the same time it is parallel with the plane 19 limiting the upper level of the water containing drain device 6. The equipment output is controlled by manual regulator 11 of the outlet device 1.

The proposed technical solution in the FIG. 8 was used for the design of a micro hydro-electric power plant on the existing weir with the level difference of 3.0 m, flow rate 0.125 to 1.0 m³·s⁻¹ and with installed capacity of 22.5 kW. The equipment in the FIG. 8 consists of the water stream guide functioning as the outlet device 1, isobaric paddles 4 fixed on the wheel 5 with horizontal rotation axis 18, drain device 6, belt transmission 7, generator 8, electric part of the micro-electric power plant 9 and of the movable equipment carrying frame 10.

The weir heaves the upper water level 3 and water runs over the weir upper edge where the falling water hydro-energetic potential is changed into the kinetic energy, which makes the water to spry via water stream guide, fulfilling the function of outlet device L in the direction of axis 2 of the outlet device 1 on the isobaric paddles 4 of the wheel 5, which creates the torque on the wheel 5 embedded on the horizontal rotation axis 18 in the movable equipment carrying frame 10. The torque is transmitted from the wheel 5 via belt transmission 7 to the generator 8. The water from paddles 4 falls on the water surface, which is identical with the plane 21 and this is identical with the plane 19 or is in lower position and at the same time it is parallel with the plane 19 limiting the upper level of the water containing drain device 6. The electric part 9 of the micro electric power plant ensures the technical parameters required for connection of generator 8 into the public electricity network. The mechanical linkage of the movable equipment carrying frame 10 with the damper ensures their mutual position so that the falling water is directed into the stream guide, fulfilling the function of outlet device 1 no matter which is the damper position.

### INDUSTRIAL UTILITY

The proposed technical solution, water wheel motor, can be used for mechanical drive of equipments on the site where the hydro-energetic potential, in the range of required operation conditions, is available.

1. A water wheel motor comprising:
a water wheel having a rotation axis;
the an outlet device located in front of the wheel; and
a drain device located under the wheel,
wherein the wheel is mounted for rotation on the rotation axis the wheel having fixed thereon paddles, wherein the paddles are isobaric.

2. The water wheel motor according to claim 1, wherein all points of the wheel and of the isobaric paddles are positioned for travel through a plane which is no lower than a plane limiting the upper level of water within a drain device space containing water.

3. The water wheel motor according to the claim 1, wherein the outlet device has an axis along which water flowing through the outlet device flows, and wherein said axis is directed on the isobaric paddles.

4. The water wheel motor according to the claim 1, wherein the rotation axis of the wheel is in oriented in a position selected from the group consisting of the vertical, horizontal and oblique positions.
